(19) United States
(12) Patent Application Publication
(10) Pub. No.: US 2024/0221191 A1
(43) Pub. Date: Jul. 4, 2024

(54) METHOD FOR IDENTIFYING CONTROL POINTS, METHOD FOR IMAGE REGISTRATION AND COMPUTER DEVICES

(71) Applicant: UNITED IMAGING RESEARCH INSTITUTE OF INNOVATIVE ME, Shenzhen (CN)

(72) Inventors: BING-SHUAI ZHAO, Shenzhen (CN); YIN-SHENG LI, Shenzhen (CN)

(21) Appl. No.: 18/399,461

(22) Filed: Dec. 28, 2023

(30) Foreign Application Priority Data
Dec. 28, 2022 (CN) 202211693126.2

(51) Int. Cl. G06T 7/33; G06T 5/50; G06T 7/11; G06T 7/174; G06V 10/26; G06V 10/74

(52) U.S. Cl. CPC G06T 7/337; G06T 5/50; G06T 7/11; G06T 7/174; G06V 10/26; G06V 10/761; G06T 2207/20021; G06T 2207/20224; G06T 2207/30048; G06T 2207/30101; G06V 2201/03

(57) ABSTRACT

This disclosure relates to a method for identifying control points, an apparatus and a computer device. Multiple image blocks are obtained by segmenting a target gradient image, and a number of control points to be selected for each image block is determined based on a first preset number of control points and pixel values within each image block. Target control points are therefore identified in the target gradient image based on image block information corresponding to each image block. The target gradient image is a gradient image of a target image of an inspected object. The target image includes any one of a mask image, a live image, or a subtracted image. The image block information includes the number of control points to be selected for the corresponding image block and a size of the image block.

### CROSS-REFERENCE TO RELATED APPLICATIONS

This application claims priority to Chinese patent application No. 202211693126.2 filed Dec. 28, 2022 and entitled “Method for Identifying Control Points, Method for Image Registration, Apparatus and Computer Devices”, which is hereby incorporated by reference in its entirety.

### TECHNICAL FIELD

This disclosure relates to the field of image processing technology, particularly to a method for identifying control points, a method for image registration, and computer devices.

### BACKGROUND

Digital Subtraction Angiography (DSA) has become an irreplaceable vascular visualization tool in clinical cardiovascular diagnosis and treatment due to its high resolution and contrast. Typically, X-ray images are taken continuously in the area of interest in the patient, followed by injection of a contrast agent. An image frame taken before the injection of the contrast agent is used as the mask image, and the real-time enhanced image obtained after the injection of the contrast agent is called as a live image. The subtracted image is obtained by subtracting the mask from the live image, which is an image that only shows the blood vessels.

### SUMMARY

One aspect of the present disclosure provides a method for identifying control points. The method includes segmenting a target gradient image to obtain multiple image blocks, the target gradient image being a gradient image of a target image of an inspected object, the target image including any one of a mask image, a live image, or a subtracted image; determining a number of control points to be selected for each image block based on a first preset number of control points and pixel values within each image block; and identifying target control points in the target gradient image based on image block information of each image block, the image block information including the number of control points to be selected for the image block and a size of the image block.

In some embodiments, the identifying target control points in the target gradient image based on image block information of each image block includes: selecting the image block that meets a preset condition as a first target image block; performing a first iteration, which includes segmenting the first target image block to obtain multiple new image blocks and determining a number of control points to be selected for each new image block based on the number of control points to be selected for the first target image block and pixel values within each new image block; performing the first iteration by selecting the new image block that meets the preset condition as a first target image block; repeating the first iteration until each newly obtained image block does not meet the preset condition, and selecting the image blocks that do not meet the preset condition in each first iteration as second target image blocks; and identifying the target control points in each second target image block based on pixel values within the second target image block.

In some embodiments, the identifying the target control points in the target gradient image based on image block information of each image block includes: determining whether each image block meets the preset condition based on the image block information of each image block; and selecting a pixel with the maximum pixel value in the image block as the target control point, if the image block does not meet the preset condition.

In some embodiments, the selecting the image block that meets the preset condition as the first target image block includes: determining that the image block meets the preset condition if the number of control points for the image block is larger than a second preset number of control points and the size of the image block is larger than a preset size; and selecting the image block that meets the preset condition as the first target image block.

In some embodiments, the determining the number of control points to be selected for each image block based on the first preset number of control points and the pixel values within each image block includes: determining a weight of each image block in the target gradient image based on the pixel values within each image block; and determining the number of control points to be selected for each image block based on the first preset number of control points and the weight of each image block.

In some embodiments, the determining the number of control points to be selected for each image block based on the first preset number of control points and the pixel values within each image block includes: determining the number of control points to be selected for each image block based on distribution of pixel values within each image block and the first preset number of control points.

Another aspect of the preset disclosure provides a method for image registration. The method includes: identifying target control points in any one of a mask image, a live image, or a subtracted image based on the method for identifying control points according to any one of the above-described embodiments, and obtaining a target subtracted image based on a target mask image and the live image, the target mask image including any one of the mask image with the target control points, an image obtained by mapping the target control points in the live image to the mask image, or an image obtained by mapping the target control points in the subtracted image to the mask image.

In some embodiments, the obtaining the target subtracted image based on the target mask image and the live image includes: determining a first similarity between the target mask image and the live image; performing a second iteration, which includes identifying matching control points in the live image corresponding to the target control points, and generating an updated target mask image based on control point pairs and the target mask image, and determining a second similarity between the updated target mask image and the live image, the control point pairs being each composed of the target control point and the corresponding matching control point; and obtaining the target subtracted image according to the first similarity and the second similarity.

In some embodiments, the obtaining the target subtracted image according to the first similarity and the second similarity includes: obtaining the target subtracted image by registering the live image and the updated target mask image if the second similarity is greater than or equal to the first similarity; or obtaining the target subtracted image by registering the live image and the target mask image if the second similarity is less than the first similarity.

In some embodiments, the obtaining the target subtracted image according to the first similarity and the second similarity includes: if the second similarity is greater than or equal to the first similarity, performing a next second iteration to determine a second similarity for the next second iteration by selecting the updated target mask image as a target mask image for the next second second iteration and selecting the second similarity as a first similarity for the next second second iteration; and if the second similarity obtained by the next second iteration is less than the first similarity for the next second iteration, obtaining the target subtracted image based on the updated target mask image obtained by the previous iteration and the live image.

In some embodiments, the method further includes selecting the matching control points in the live image as reference starting points for registering the target mask and a next live image.

In some embodiments, the identifying the target control points in the target gradient image based on image block information of each image block includes: selecting the image block that meets a preset condition as a first target image block; performing a first iteration including segmenting the first target image block to obtain multiple new image blocks and determining a number of control points to be selected in each new image block based on the number of control points to be selected for the first target image block and pixel values within each new image block; performing the first iteration by selecting the new image block that meets the preset condition as a first target image block; repeating the first iteration until each newly obtained image block does not meet the preset condition, and selecting the image blocks that do not meet the preset condition in each first iteration as second target image blocks; and identifying the target control points in each second target image block based on pixel values within the second target image block.

In some embodiments, the identifying the target control points in the target gradient image based on image block information of each image block includes: determining whether each image block meets the preset condition based on the image block information of each image block; and selecting the pixel with the maximum pixel value in the image block as the target control point, if the image block does not meet the preset condition.

In some embodiments, the selecting the image block that meets the preset condition as the first target image block includes: determining that the image block meets the preset condition if the number of control points for the image block is larger than a second preset number of control points and the size of the image block is larger than a preset size; and selecting the image block that meet the preset condition as the first target image block.

In some embodiments, the determining the number of control points to be selected for each image block based on the first preset number of control points and the pixel values within each image block includes: determining a weight of each image block in the target gradient image based on the pixel values within each image block; and determining the number of control points to be selected for each image block based on the first preset number of control points and the weight of each image block.

In some embodiments, the determining the number of control points to be selected for each image block based on the first preset number of control points and the pixel values within each image block includes: determining the number of control points to be selected for each image block based on distribution of pixel values within each image block and the first preset number of control points.

Yet another aspect of the preset disclosure provides a computer device which includes a memory and a processor. The memory stores a computer program. The processor, when executing the computer program, is configured to perform the method for identifying control points according to any one of the above-described embodiments.

Yet another aspect of the preset disclosure provides a computer device which includes a memory and a processor. The memory stores a computer program. The processor, when executing the computer program, is configured to perform the method for image registration according to any one of the above-described embodiments.

Yet another aspect of the preset disclosure provides a non-transitory computer-readable medium having stored thereon a computer program. The computer program, when executed by a processor, causes the processor to perform the method for identifying control points according to any one of the above-described embodiments.

Yet another aspect of the preset disclosure provides a non-transitory computer-readable medium having stored thereon a computer program. The computer program, when executed by a processor, causes the processor to perform the method for image registration according to any one of the above-described embodiments.

The details of the various embodiments of the present disclosure will be illustrated with the accompanying drawings and description below, based on which, other features, problems to be solved, and beneficial effects of the disclosure will be readily understood by those skilled in the art.

### BRIEF DESCRIPTION OF THE DRAWINGS

FIG. 1 shows an application environment of a method for identifying control points according to an embodiment of the present disclosure.

FIG. 2 is a schematic flowchart of a method for identifying control points according to an embodiment of the present disclosure.

FIG. 3 is a schematic flowchart of identifying target control points according to an embodiment of the present disclosure.

FIG. 4A is a schematic diagram of a target control point according to an embodiment of the present disclosure.

FIG. 4B is a schematic diagram of a target control point according to another embodiment of the present disclosure.

FIG. 5 is a schematic flowchart of determining the number of control points to be selected for each image block according to an embodiment of the present disclosure.

FIG. 6 is a schematic flowchart of a method for image registration according to an embodiment of the present disclosure.

FIG. 7 is a schematic flowchart of a method for image registration according to another embodiment of the present disclosure.

FIG. 8 is the first schematic target subtracted image according to an embodiment of the present disclosure.

FIG. 9A is the second schematic target subtracted image according to an embodiment of the present disclosure.

FIG. 9B is the third schematic target subtracted image according to an embodiment of the present disclosure.

FIG. 9C is the fourth schematic target subtracted image according to an embodiment of the present disclosure.

FIG. 9D is the fifth schematic target subtracted image according to an embodiment of the present disclosure.

FIG. 10 is a block diagram of a control point identification apparatus according to an embodiment of the present disclosure.

### DETAILED DESCRIPTION

To make the purpose, technical solution, and advantages of the present disclosure more clear and understandable, the following detailed description is given in conjunction with the drawings and embodiments. It should be understood that the specific embodiments described herein are merely illustrative to explain the present disclosure and are not intended to limit the scope of the present disclosure.

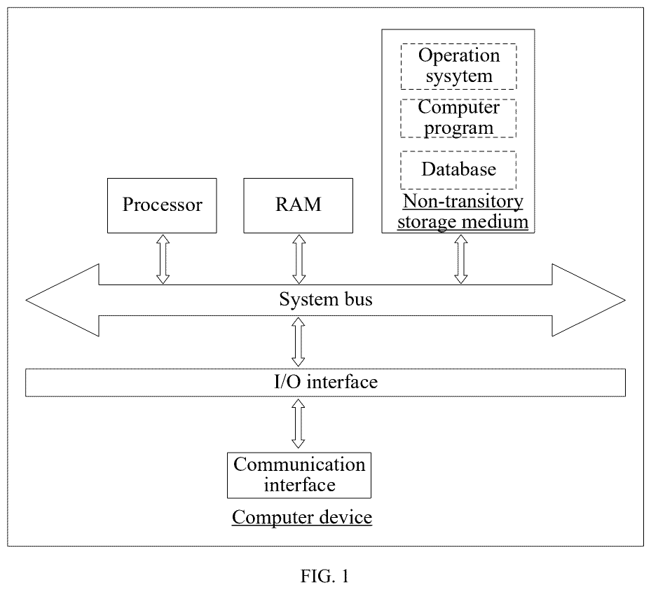

The method for identifying control points provided in the embodiments of the present disclosure can be applied in an application environment as shown in FIG. 1. The application environment includes a computer device, which may be a server, with its internal structure illustrated in FIG. 1. The computer device includes a processor, a memory, and a network interface connected via a system bus. The processor of the computer device provides computing and control capabilities. The memory of the computer device includes a non-transitory storage medium and random access memory. The non-transitory storage medium stores the operating system, computer programs, and databases. The random access memory provides an environment for running the operating system and computer programs stored in the non-transitory storage medium. The database of the computer device is used to store image registration-related data. The network interface of the computer device is used to communicate with external terminals through a network connection. The computer program is executed by the processor to perform the method for identifying control points. The server can be implemented as a single server or a server cluster composed of multiple servers.

Those in the field can understand that FIG. 1 only shows part of the components related to the present disclosure, and does not constitute a limitation on the computer device that implements the solutions provided by the present disclosure. The computer device may include more or fewer components than shown in the figure, combine certain components, or have a different arrangement of components.

The mask image and the live image are acquired at different moments, and during the time gap, the inevitable patient movements such as body motion, respiration, cardiac pulsation, and visceral organ peristalsis can cause misalignment between corresponding pixels of the mask image and the live image. This leads to significant motion artifacts in the subtracted vascular image, which reduces the diagnostic value of digital subtraction angiography (DSA). Therefore, accurately obtaining control points and improving image registration based on them has become an urgent issue that needs to be addressed.

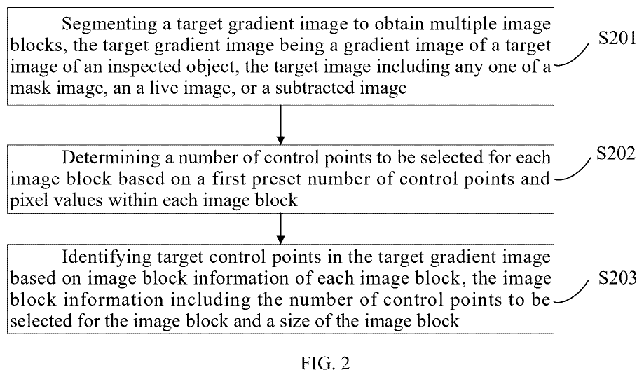

In an embodiment, as shown in FIG. 2, the present disclosure provides a method for identifying control points. Taking the implementation with the computer device as shown in FIG. 1 as an example, the method includes the following steps S201-S203.

In step S201, a target gradient image is segmented to obtain multiple image blocks. The target gradient image is a gradient image of a target image of an inspected object, and the target image can be any one of a mask image, alive image, or a subtracted image.

The subtracted image is obtained by subtracting the mask image from the live image. By applying a gradient filter to derive the target image, the gradient image can be obtained. For example, algorithms such as Sobel edge detection, Scharr algorithm, or Laplacian algorithm can be used. The gradient image contains a significant amount of edge feature information from the target image. In the edge regions of an image, the grayscale values change significantly, and the gradient values are also large. In the smooth parts of the image, the grayscale values change less, and the corresponding gradient values are small.

In an embodiment, various methods such as quadtree, binary search, ternary search, etc., can be used to segment the target gradient image to obtain the multiple image blocks. This segmentation process aims to facilitate subsequent operations such as matching and registration, ultimately improving the quality and accuracy of DSA images. It should be noted that the specific segmentation method can be chosen and optimized based on practical considerations.

In step S202, a number of control points to be selected for each image block is determined based on a first preset number of control points and pixel values within each image block.

Control points refer to reference points selected in an image for establishing geometric transformation functions, which are used for image registration in this disclosure. In general, corresponding control points from two matched images are referred to as a control point pair. Each control point has a set of coordinates.

The pixel values within an image block refer to the values of all pixels within the image block.

The first preset number of control points refers to the preset number of control points to be selected in the target gradient image.

In this embodiment, for each image block, the pixel values within the image block can be accumulated to obtain a first pixel sum of the image block. By accumulating the pixel values of all image blocks, a second pixel sum of the target gradient image can be obtained. The pixel weight for each image block can be calculated by normalizing the first pixel sum and the second pixel sum. Based on the pixel weights and the first preset number of control points, the number of control points to be selected for each image block can be determined.

In some possible implementations, the number of control points to be selected for each image block can be determined based on the distribution of pixel values within the image block. For example, the number of neighboring pixel pairs having a large pixel value change in each image block is counted. That is, if the difference between any neighboring pixels is greater than a predetermined threshold, the number of counts is increased by one. Based on the final number of counts for each image block and the first preset number of control points, the number of control points to be selected for each image block is determined.

In step S203, target control points are identified in the target gradient image based on image block information of each image block. The image block information includes the number of control points to be selected for the image block and the size of the image block.

In some embodiments, identifying the target control points in the target gradient image based on the image block information of each image block includes identifying the target control points in the target gradient image if the number of control points to be selected for each image block and the size of each image block meet certain conditions.

When identifying the target control points in the target gradient image, the point with the maximum pixel value in one image block can be used as the target control point, or the center point of one image block can be used as the target control point. Alternatively, feature points extracted through algorithms such as Harris corner algorithm, Scale-invariant Feature Transform (SIFT), Speeded Up Robust Features (SURF), Oriented FAST and Rotated BRIEF (ORB) algorithm, Features from Accelerated Segment Test (FAST), and Small Univalue Segment Assimilating Nucleus (SUSAN) corner detection algorithm can be used as the target control points.

According to the method for identifying control points described above, multiple image blocks are obtained by segmenting the target gradient image. Based on the first preset number of control points and the pixel values within each image block, the number of control points to be selected for each image block is determined, and then the target control points are identified in the target gradient image based on the image block information of the image blocks. The target gradient image is a gradient image of a target image of an inspected object, and the target image includes any one of the mask image, the live image, or the subtracted image. The image block information includes the number of control points to be selected for the corresponding image block and the size of the image block. In the disclosure, identifying the target control points in the target gradient image fully utilizes the feature information of the image. Moreover, the first preset number of control points is distributed based on the pixel values with each image block, avoiding the uniform distribution as in the existing technology. Consequently, the identified target control points are reasonably distributed in the area of the target gradient image with abundant edge information and many artifacts, improving the accuracy of identifying target control points.

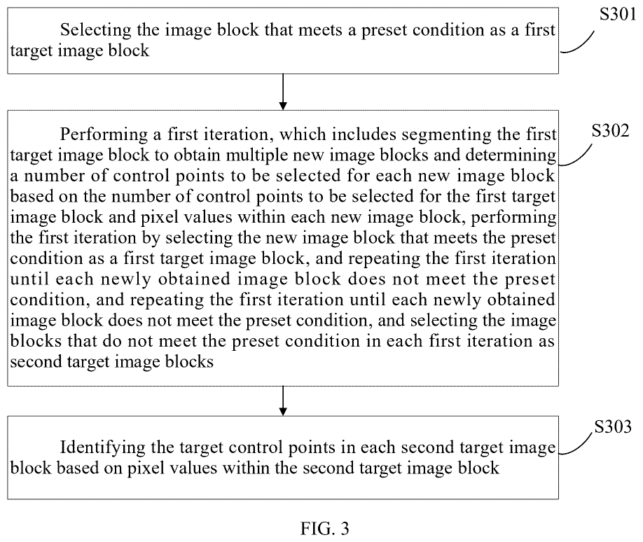

FIG. 3 illustrates a flowchart of identifying target control points in an embodiment. As shown in FIG. 3, the embodiment provides a possible implementation for identifying target control points in the target gradient image based on the image block information of each image block. The method includes the following steps: S301-S303.

In step S301, the image block that meets a preset condition is selected as a first target image block.

In some embodiments, if the number of control points for an image block is greater than a second preset number of control points and the size of the image block is larger than a preset size, the image block can be determined to meet the preset condition and thus selected as the first target image block. In an example where the second preset number of control points is 1 and the preset size is 10*10, an image block can be selected as the first target image block if it meets both the conditions.

If the size of an image block or the number of control points for the image block does not meet the preset condition, it indicates that the image block cannot be further segmented. For example, even if an image block has more than one control point, it cannot be further segmented due to its size of, for example, 5*5. In such cases, only the pixel with the maximum pixel value in the image block can be selected as the target control point, according to some embodiments.

In step S302, a first iteration operation is performed, which includes segmenting the first target image block to obtain multiple new image blocks, and based on the number of control points for the first target image block and the pixel values within each new image block, the number of control points to be selected for each new image block is determined. The new image block that meets the preset condition is selected as a first target image block and the first iteration is repeated until each newly obtained image block no longer meets the preset condition.

In this embodiment, the segmentation algorithm is used to segment the first target image block into multiple new image blocks for the current iteration. Based on the number of control points for the first target image block and the pixel values within each new image block, the number of control points to be selected for each new image block is determined. It is then determined whether each new image block meets the preset condition. If the condition is met, the segmentation continues to be performed on the image blocks that meet the preset condition until each newly obtained image block no longer meets the preset condition.

In step S303, the target control points are identified in the second target image blocks based on pixel values within each second target image block. The second target image blocks include image blocks that were determined in each iteration but did not meet the preset condition.

In this embodiment, the target control points are identified in image blocks that are obtained in each iteration and do not meet the preset condition. When a newly obtained image block cannot be further segmented, a target control point(s) is(are) identified in this image block based on the pixel values within this image block that cannot be further segmented.

It should be noted that the same selection method or different selection methods can be used to identify the target control points in the image blocks that cannot be further segmented.

In this embodiment, the target control points in the target gradient image are identified through multiple iterations based on pixel values. By utilizing the characteristic information of the target gradient image, the identified target control points are more accurate, enabling a more precise registration of the corresponding pixels in the mask image and the live image.

In an embodiment, the method for identifying control points further includes determining whether each image block meets the preset condition based on the image block information. If any image block does not meet the preset condition, the pixel with the maximum pixel value within the image block is selected as the target control point.

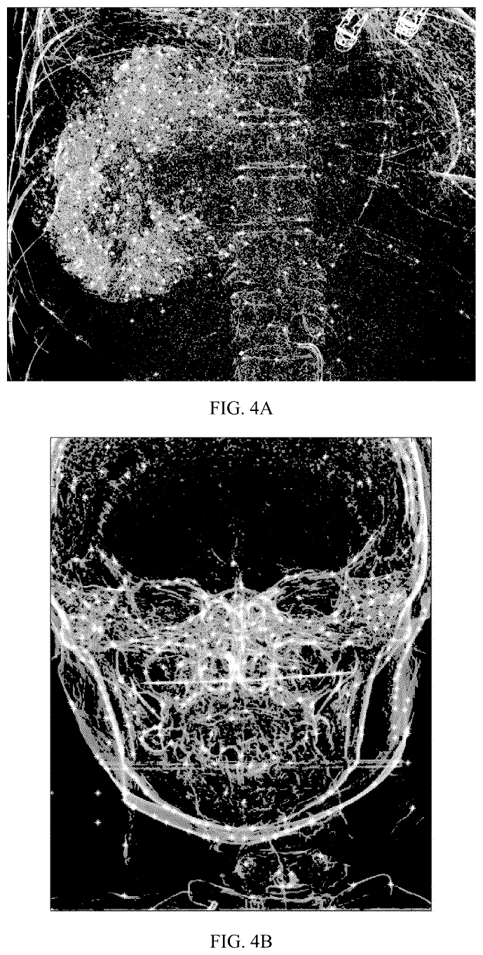

In this embodiment, when none of the image blocks meets the preset condition, i.e., when none of the image blocks can be further segmented, the pixel with the maximum pixel value within each image block is identified as the target control point. Namely, a point with the local maximum gradient within each image block is identified as the control point. Since the point with the local maximum gradient reflects the area with the highest pixel variation within an image block, as shown in FIGS. 4A and 4B, the control points identified based on the target gradient image mainly concentrate on the edges, with fewer control points in non-edge regions. Thus, the control points are distributed reasonably in areas of the target gradient image with rich edge information and significant artifacts.

FIG. 5 is a schematic flowchart of determining the number of control points to be selected for each image block in an embodiment. As shown in FIG. 5, this embodiment relates to a possible implementation for determining the number of control points to be selected for each image block based on the first preset number of control points and the pixel values within each image block. The process includes the following steps S501 and S502.

In step S501, a weight of each image block in the target gradient image is determined based on the pixel values within the image block.

In this embodiment, the first pixel sum of each image block and the second pixel sum of the target gradient image can be calculated using the pixel values. The weight of each image block in the target gradient image is then obtained by dividing second pixel sum by the first pixel sum.

In step S502, the number of control points to be selected for each image block is determined based on the first preset number of control points and the weight of each image block.

In some embodiments, the first preset number of control points is multiplied by the weight of each image block to obtain the number of control points to be selected for that image block.

This can also be understood in another way. That is, the number of control points to be selected for each image block can be directly determined based on the ratio between the first pixel sums of the image blocks as well as the first preset number of control points. For example, if the first pixel sums of four image blocks are 20,000, 30,000, 30,000, and 20,000 respectively, and the first preset number of control points is 100, then the number of control points to be selected for each image block will be 20, 30, 30, and 20, respectively.

In the embodiments, the number of control points to be selected for each image block is determined based on the pixel values within each image block and the first preset number of control points. This process is simple and can be quickly realized.

The essence of removing motion artifacts is an image registration process, which is also called pixel shift. It aligns the same anatomical structures in space between the mask image and the live image, and then performs digital subtraction to remove bone and soft tissue, leaving only the vascular image, which is the subtracted image. This disclosure provides a method for image registration, and taking the implementation with the computer device shown in FIG. 1 as an example, the method includes:
identifying target control points in a target gradient image using the above-described method for identifying control points, the target gradient image being a gradient image of any one of a mask image, a live image, or a subtracted image;
selecting any one of the following images as a target mask image: the mask image with the target control points, an image obtained by mapping the target control points in the live image to the mask image, or an image obtained by mapping the target control points in the subtracted image to the mask image; and
obtaining a target subtracted image based on the target mask image and the live image.

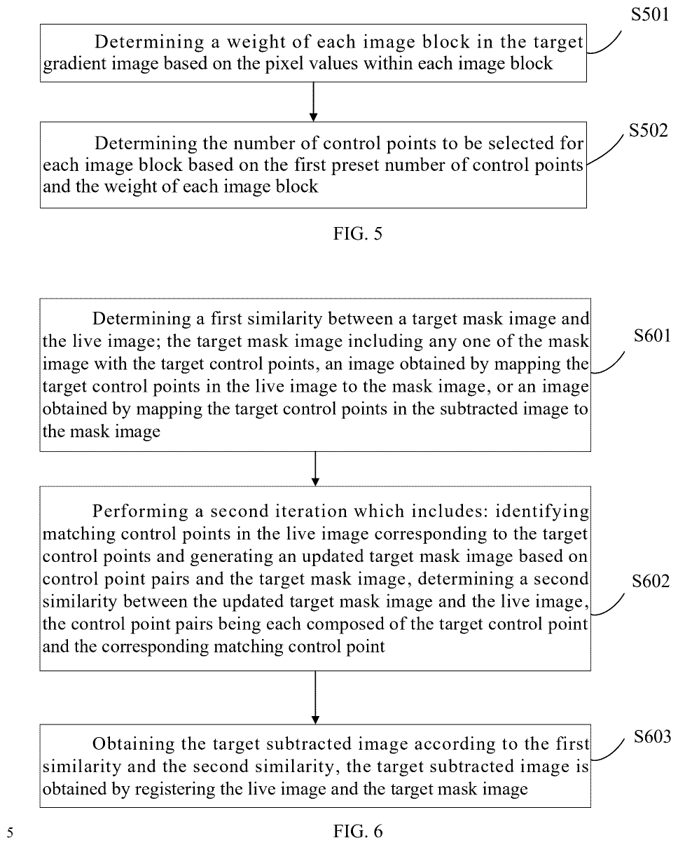

In a specific embodiment, as shown in FIG. 6, the method for image registration includes the following steps S601-S603.

In step S601, a first similarity between the target mask image and the live image is determined. The target mask image includes the mask image with the target control points, an image obtained by mapping the target control points in the live image to the mask image, or an image obtained by mapping the target control points in the subtracted image to the mask image. The control points can be identified by the methods described in any of the previous embodiments.

It should be understood that the identification of control points can be directly performed on the mask image to obtain the target mask image, and alternatively, it can be performed on the live image or the subtracted image and then the identified control points are mapped to the mask image to obtain the target mask image.

In some embodiments, various similarity measurement algorithms such as Mutual Information (MI), Normalized Mutual Information (NMI), Correlation Coefficient (CC), Energy of the histogram of differences (EHD), and Sum of Squared Differences (SSD) can be used to determine the first similarity between the target mask image and the live image.

In step S602, a second iteration is performed, which includes identifying matching control points in the live image corresponding to the target control points in the target mask image, and generating an updated target mask image for the current iteration based on control point pairs and the target mask image. A second similarity between the updated target mask image and the live image for the current iteration is also determined. The control point pairs each include one target control point and one corresponding matching control point.

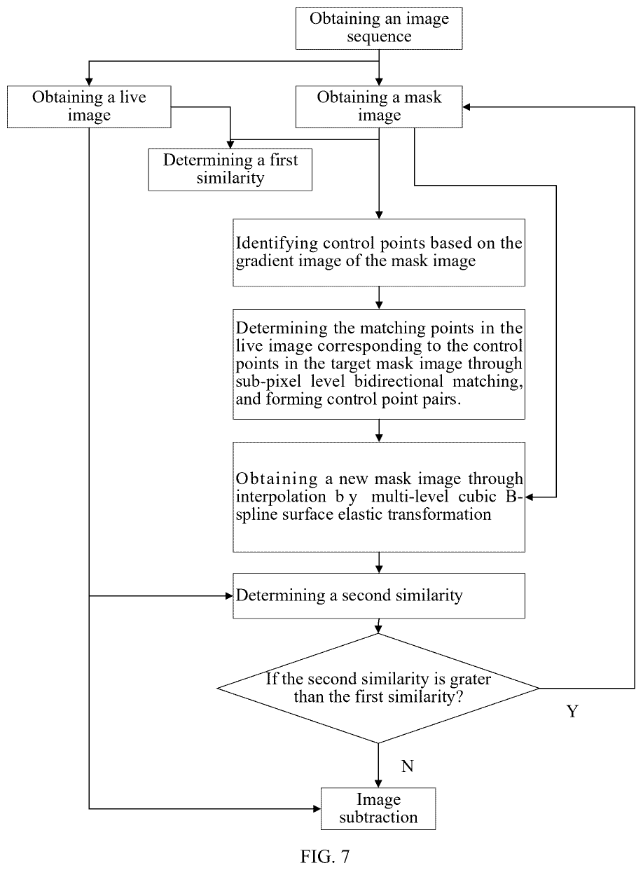

In some embodiments, as shown in FIG. 7, block matching algorithms for bidirectional matching can be used to determine control point pairs between the target mask image and the live image. For example, exhaustive search (ES), three-step search (TSS), new three-step search (NTSS), four-step search (FSS), simple and efficient search (SES), diamond search (DS), hexagon-based search (HEXBS), Powell fast search (PFS), etc. can be utilized.

In a possible implementation, the block matching search algorithm is employed to find the most similar first matching block in the live image for a block containing the target control point CP1 in the target mask image. This can be achieved using the method based on the subtraction histogram energy. The matching control point CP2 in the first matching block corresponding to the target control point CP1 is then determined. For instance, the block containing the target control point CP1 is established by selecting the control point CP1 as the center point thereof, and acts as a search window to search for the first matching block. The center of the first matching block is then considered as the matching control point CP2 in the live image corresponding to the target control point CP1. Thus, a control point pair (CP1, CP2) is formed. The search window and the first matching block can have the same size, such as 100*100.

Using a similar matching approach and considering the matching control point CP2 as a control point, a second matching block in the target mask image, which is most similar to the block containing the matching control point CP2 in the live image, can be searched for. The center of the second matching block becomes a matching control point CP3 corresponding to the matching control point CP2. If the distance between the points CP3 and CP1 is smaller than a predetermined threshold, the control point pair (CP1, CP2) is considered a valid pair. Otherwise, the matching process is repeated.

In some embodiments, after the control point pair (CP1, CP2) has been determined, the block containing the target control point CP1 and the block containing the matching control point CP2 are enlarged by the same factor through interpolation (e.g., 10 times). The block matching algorithm is then used again to search for the matching block in the live image corresponding to the target control point CP1. An obtained motion vector, which represents the positional difference between the target control point CP1 and the matching control point CP2, can be thus obtained. A sub-pixel level motion vector can be further obtained by dividing the motion vector with the enlargement factor. This sub-pixel level motion vector is used to update the coordinates of the control point pair (CP1, CP2), resulting in a more accurate match. For example, a positional difference of the control point pair (CP1, CP2) determined by the previous method is (5, 10), while by performing interpolation with the same enlargement factor and conducting a new search, the positional difference of the control point pair (CP1, CP2) may become (5.9, 10.8), thus achieving a more precise positional difference for the control point pair.

In some embodiments, the target mask image needs to be registered with multiple consecutive live images, while keeping the positions of the target control points unchanged. When establishing control point pairs between the target mask image and a first live image, a control point pair (CP1, CP2) is obtained. When it needs to establish control point pairs between the target mask image and a second live image following the first live image, the desired matching control point can be identified near the matching control point CP2, without repeating the process of identifying the matching control point in the first live image. For example, the previously identified matching control point in the previous live image can be used as the reference starting point when matching the target mask with a next live image, ensuring the coherence between frames. This approach reduces computational complexity and avoids flickering between frames. For instance, when identifying the matching control point for a next live image, the previously identified matching control point in the previous live image can be used as the reference starting position for searching for a corresponding matching block in the next live image.

In some possible implementations, an updated target mask image is generated based on the control point pairs and the target mask image. The second similarity between the updated target mask image and the live image is then calculated. In some embodiments, the updated target mask image can be generated using registration algorithms such as cubic B-spline surface elastic transformation, affine transformation, or thin-plate spline elastic transformation.

In step S603, a target subtracted image is determined according to the first similarity and second similarity. The target subtracted image is obtained by registering the live image and the target mask image.

In this embodiment, if the first similarity is greater than the second similarity of the current iteration, the target subtracted image is obtained based on the target mask image corresponding to the first similarity and the live image. If the first similarity is not greater than the second similarity of the current iteration, the target subtracted image is obtained based on the updated target mask image corresponding to the second similarity and the live image. Specifically, this can be achieved by directly using the updated target mask image corresponding to the second similarity and the live image to obtain the target subtracted image. Alternatively, the updated target mask image can be further optimized, and then the target subtracted image can be obtained based on the optimized mask image and the live image.

In some embodiments, the determination of the target subtracted image according to the first similarity and second similarity can include: if the second similarity is greater than or equal to the first similarity, the updated target mask image is selected as a target mask image, the second similarity is selected as a first similarity for a next second iteration, and the process returns to perform the next second iteration to determine the second similarity obtained by the next second iteration; and if the second similarity obtained by the next second iteration is less than the first similarity for the next second iteration, the target subtracted image is obtained based on the updated target mask image obtained by the previous iteration and the live image.

In this embodiment, when the second similarity is greater than or equal to the first similarity, it indicates that the updated target mask image and the subtracted image are more similar, and the elastic transformation registration algorithm is effective. Accordingly, the updated target mask image is selected as a target mask image, the second similarity is selected as a first similarity for the next second iteration, and the process returns to perform the second iteration to generate another updated target mask image until the second similarity for the next second iteration is less than the first similarity for the next second iteration. At this point, the similarity between the updated target mask image and the live image no longer increases but starts to decrease, and the iteration process is stopped. The updated target mask image obtained in the previous iteration is thus the most similar to the live image. Consequently, the target subtracted image is obtained based on the previously updated target mask image and the live image, resulting in the minimum motion artifacts in the target subtracted image.

The method for registration proposed in the embodiments utilizes the strategy of iterative transformation on a single frame, where the updated target mask generated by the previous elastic transformation is considered as the input for the next elastic transformation when the iteration condition is met, such that the registration results between the updated target mask image and the live image can be retained and used until an iteration termination condition is met. At this point, the previously updated target mask image is the one most similar to the live image, and the final target subtracted image will have the least artifacts.

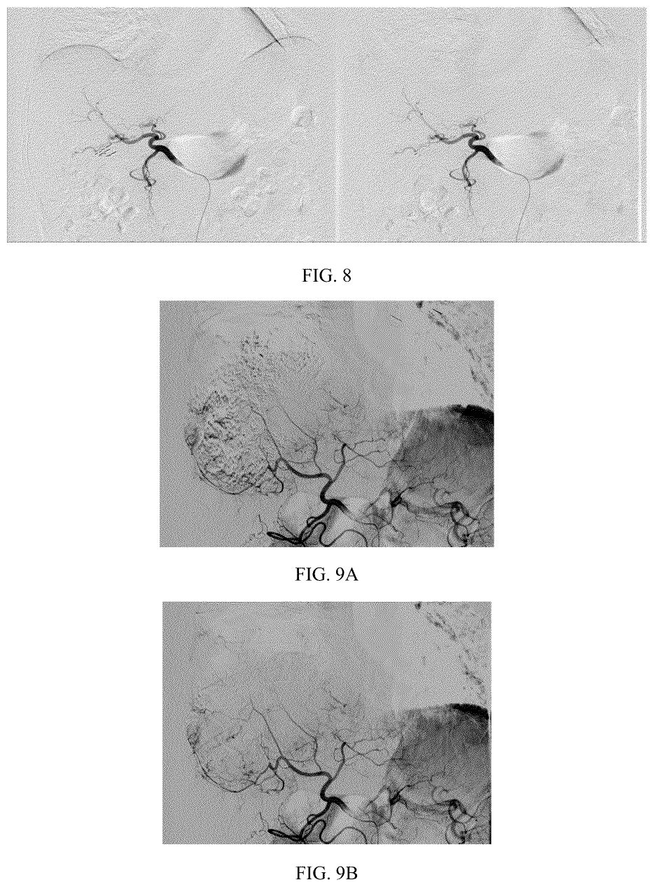

In an embodiment, as shown in FIG. 8, the left side of FIG. 8 is a subtracted image obtained directly based on a live image and a mask image, while the right side is a subtracted image obtained through the methods proposed in this disclosure. It can be seen that the image quality of the ribs on the left, the diaphragm on the top, and the intestinal gas on the right and bottom have all been significantly improved, and the contrast between blood vessels and background is evident. It can be found that the method is very effective in dealing with both small and large motion artifacts, and the resulting subtracted image removes the majority of the artifacts, significantly improving the quality of the subtracted image.

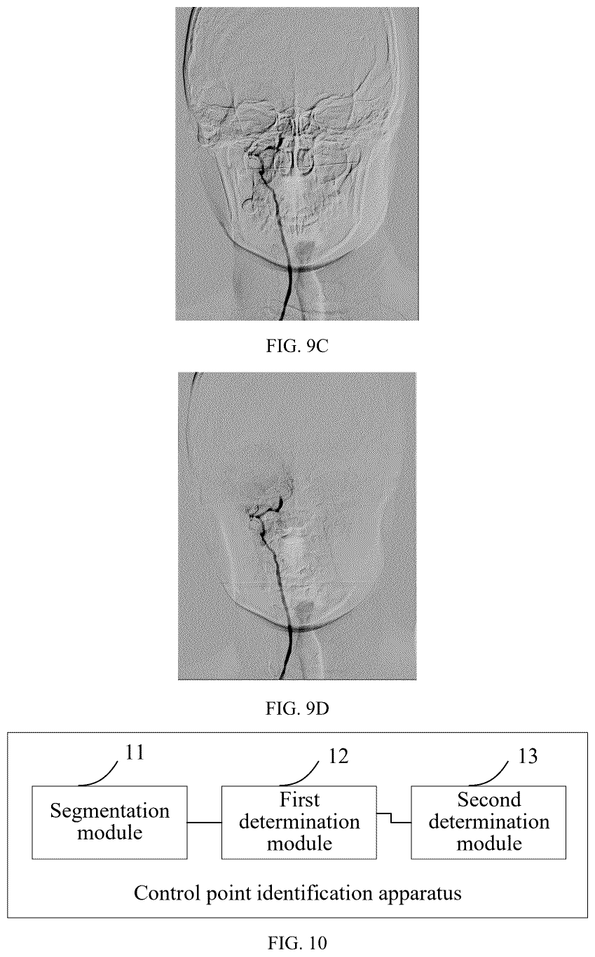

In an embodiment, FIG. 9A and FIG. 9B are subtracted images corresponding to FIG. 4A, while FIGS. 9C-9D are subtracted images corresponding to FIG. 4B. FIG. 9A and FIG. 9C are subtracted images obtained directly based on a mask image and a live image, while FIG. 9B and FIG. 9D are subtracted images obtained through the method proposed in this disclosure. It can be seen that after using the method proposed in this disclosure, the contrast of blood vessels in the subtracted image is significantly enhanced, and most of the motion artifacts are eliminated, improving the quality of the subtracted image and significantly enhancing the diagnostic value of the subtracted image.

It should be understood that although the steps in the flowcharts of the above embodiments are shown sequentially according to the direction of the arrows, these steps are not necessarily performed strictly in the order indicated by the arrows. Unless otherwise specified in this document, the execution of these steps is not strictly limited to a specific order, and they can be performed in other orders. Additionally, at least some of the steps in the flowcharts of the above embodiments may include multiple sub-steps or stages, which do not necessarily need to be completed simultaneously but can be executed at different times. The execution order of these steps or stages is not necessarily sequential but can be performed alternately or interchangeably with other steps or at least some parts of other steps or stages.

Based on the same inventive concept, the present disclosure provides a control point identification apparatus to implement the above-described method. The solutions provided by the apparatus are similar to those described in the above method. Therefore, the specific limitations of the control point identification apparatus in the following exemplary embodiments can be referred to in the previous description of the method for identifying control points and will not be repeated here.

In an embodiment, as shown in FIG. 10, a control point identification apparatus is provided, which includes a segmentation module 11, a first determination module 12, and a second determination module 13.

The segmentation module 11 is configured to segment a target gradient image into multiple image blocks. The target gradient image is a gradient image of a target image of an inspected object, and the target image includes any one of a mask image, a live image, or a subtracted image.

The first determination module 12 is configured to determine a number of control points to be selected for each image block based on a first preset number of control points and pixel values within each image block.

The second determination module 13 is configured to identify target control points in the target gradient image based on image block information of each image block. The image block information includes a number of control points to be selected in the corresponding image block and a size of the image block.

In an embodiment, the second determination module includes a first determination unit, a performing unit, and a second determination unit.

The first determination unit is configured to select the image block that meets a preset condition as a first target image block.

The performing unit is configured to perform a first iteration, which includes segmenting the first target image block to obtain multiple new image blocks for the current iteration, and determining the number of control points to be selected for each new image block based on the number of control points for the first target image block and the pixel values within each new image block; and repeating the first iteration by selecting the new image block that meets the preset condition as a first target image block, until newly obtained image blocks no longer meet the preset condition.

The second determination unit is configured to determine the target control points in each second target image block based on the pixel values within each second target image block. The second target image blocks include image blocks that are determined in each iteration but do not meet the preset condition.

In an embodiment, the second determination module further includes a third determination unit and a fourth determination unit.

The third determination unit is configured to determine whether each image block meets the preset condition based on the image block information.

The fourth determination unit is configured to select the pixel with the maximum pixel value in the image block as the target control point if the image block does not meet the preset condition.

In an embodiment, the first determination unit is also configured to determine, if the number of control points corresponding to an image block is greater than a second preset number of control points and the size of the image block is greater than a preset size, the image block to meets the preset condition and select the image block that meets the preset condition as the first target image block.

In an embodiment, the first determination module includes a fifth determination unit and a sixth determination unit.

The fifth determination unit is configured to determine the weight of each image block in the target gradient image based on the pixel values within each image block.

The sixth determination unit is configured to determine a number of control points to be selected for each image block based on the first preset number of control points and the weight of each image block.

In an embodiment, an image registration apparatus is provided. The apparatus includes a third determination module, a performing module, or a fourth determination module.

The third determination module is configured to determine a first similarity between the target mask image and the live image. The target mask image includes the mask image, an image obtained by mapping the target control points in the live image to the mask image, and an image obtained by mapping the target control points in the subtracted image to the mask image. The target control points can be identified using any method in the embodiments described above.

The performing module is configured to perform a second iteration, which includes identifying matching control points in the live image corresponding to the target control points in the target mask image, and generating an updated target mask image for the current iteration based on control point pairs and the target mask image. A second similarity between the updated target mask image and the live image for the current iteration is also determined. The control point pairs each include one target control point and one corresponding matching control point.

The fourth determination module is configured to obtain a target subtracted image according to the first similarity and the second similarity. The target subtracted image is the image obtained by registering the live image and the target mask image.

In an embodiment, the fourth determination module includes a seventh determination unit and an eighth determination unit.

The seventh determination unit is configured to select the updated target mask image as the target mask image if the second similarity is greater than or equal to the first similarity, select the second similarity as the first similarity for a next second iteration, and return to perform the next second iteration to determine the second similarity obtained by the next second iteration.

The eighth determination unit is configured to, if the second similarity obtained by the next second iteration is less than the first similarity for the next second iteration, obtain the target subtracted image based on the updated target mask image obtained by the previous iteration and the live image.

The various modules in the aforementioned control point determination apparatus can be fully or partially implemented through software, hardware, or their combination. These modules can be embedded in hardware within or independent of the processor in a computer device, or stored in software form in the memory of the computer device, facilitating the processor's invocation and execution of the corresponding operations of the modules.

In an embodiment, a computer device is provided which includes a memory and a processor. A computer program is stored in the memory, and the processor when executing the computer program is configured to perform the following steps:
segmenting a target gradient image to obtain multiple image blocks, the target gradient image being a gradient image of a target image of an inspected object, the target image including any one of a mask image, a live image, or a subtracted image;
determining a number of control points to be selected for each image block based on a first preset number of control points and pixel values within each image block; and
identifying target control points in the target gradient image based on image block information of each image block, the image block information including the number of control points to be selected for the image block and a size of the image block.

In an embodiment, the processor when executing the computer program is also configured to perform the following steps:
selecting the image block that meets a preset condition as a first target image block;
performing a first iteration, which includes: segmenting the first target image block to obtain multiple new image blocks for the current iteration and determining the number of control points to be selected for each new image block based on the number of control points for the first target image block and the pixel values within each new image block, and repeating the first iteration by selecting the new image block that meets the preset condition as a first target image block, until newly obtained image blocks no longer meet the preset condition; and
determining the target control points in each second target image block based on the pixel values within each second target image block, the second target image blocks including image blocks that are determined in each iteration but do not meet the preset condition.

In an embodiment, the processor when executing the computer program is also configured to perform the following steps:
determining whether each image block meets the preset condition based on the image block information of the image block; and
selecting the pixel with the maximum pixel value in each image block as the target control point if the image block does not meet the preset condition. In an embodiment, the processor when executing the computer program is also configured to perform the following step:
determining, if the number of control points corresponding to an image block is greater than a second preset number of control points and the size of the image block is greater than a preset size, the image block to meet the preset condition and selecting the image block that meets the preset condition as the first target image block.

In an embodiment, the processor when executing the computer program is also configured to perform the following steps:
determining the weight of each image block in the target gradient image based on the pixel values within each image block; and
determining a number of control points to be selected for each image block based on the first preset number of control points and the weight of each image block.

In an embodiment, the processor when executing the computer program is also configured to perform the following steps:
determining a first similarity between the target mask image and the live image, the target mask image including the mask image, an image obtained by mapping the target control points in the live image to the mask image, or an image obtained by mapping the target control points in the subtracted image to the mask image, the target control points being identified using any method in the embodiments described above;
performing a second iteration, which includes identifying matching control points in the live image corresponding to the target control points in the target mask image, generating an updated target mask image for the current iteration based on control point pairs and the target mask image, and determining a second similarity between the updated target mask image and the live image for the current iteration, the control point pairs each including one target control point and one corresponding matching control point; and
determining a target subtracted image according to the first similarity and the second similarity, the target subtracted image being the image obtained by registering the live image and the target mask image.

In an embodiment, the processor when executing the computer program is also configured to perform the following steps:
if the second similarity is greater than or equal to the first similarity, performing a next second iteration to determine a second similarity obtained by the next second iteration by selecting the updated target mask image as a target mask image and the second similarity as a first similarity for the next second iteration; and
obtaining the target subtracted image based on the updated target mask image obtained by the previous iteration and the live image if the second similarity obtained by the next second iteration is less than the first similarity for the next second iteration.

In an embodiment, a computer-readable storage medium is provided on which a computer program is stored, the computer program when executed by a processor implements the following steps:
segmenting a target gradient image to obtain multiple image blocks, the target gradient image being a gradient image of a target image of an inspected object, the target image including any one of a mask image, a live image, or a subtracted image;
determining a number of control points to be selected for each image block based on a first preset number of control points and pixel values within each image block; and
identifying target control points in the target gradient image based on image block information of each image block, the image block information including the number of control points to be selected for the image block and a size of the image block.

In an embodiment, the computer program when executed by the processor also implements the following steps:
selecting the image block that meets a preset condition as a first target image block;
performing a first iteration, which includes segmenting the first target image block to obtain multiple new image blocks for the current iteration and determining the number of control points to be selected for each new image block based on the number of control points for the first target image block and the pixel values within each new image block, and repeating the first iteration by selecting the new image block that meets the preset condition as the first target image block, until newly obtained image blocks no longer meet the preset condition; and
determining the target control points in each second target image block based on the pixel values within each second target image block, the second target image blocks including image blocks that are determined in each iteration but do not meet the preset condition.

In an embodiment, the computer program when executed by the processor also implements the following steps:
determining whether each image block meets the preset condition based on the image block information of the image block; and
selecting the pixel with the maximum pixel value within each image block as the target control point if the image block does not meet the preset condition.

In an embodiment, the computer program when executed by the processor also implements the following step:
determining, if the number of control points corresponding to an image block is greater than a second preset number of control points and the size of the image block is greater than a preset size, the image block to meet the preset condition and selecting the image block that meet the preset condition as the first target image block.

In an embodiment, the computer program when executed by the processor also implements the following steps:
determining the weight of each image block in the target gradient image based on the pixel values within each image block; and
determining a number of control points to be selected for each image block based on the first preset number of control points and the weight of each image block.

In an embodiment, the computer program when executed by the processor also implements the following steps:
determining a first similarity between the target mask image and the live image, the target mask image including the mask image, an image obtained by mapping the target control points in the live image to the mask image, or an image obtained by mapping the target control points in the subtracted image to the mask image, the target control points being identified using any method in the embodiments described above;
performing a second iteration, which includes identifying matching control points in the live image corresponding to the target control points in the target mask image, generating an updated target mask image for the current iteration based on control point pairs and the target mask image, and determining a second similarity between the updated target mask image and the live image for the current iteration, the control point pairs each including one target control point and one corresponding matching control point; and
obtaining a target subtracted image according to the first similarity and the second similarity, the target subtracted image being the image obtained by registering the live image and the target mask image.

In an embodiment, the computer program when executed by the processor also implements the following steps:
if the second similarity is greater than or equal to the first similarity, performing a next second iteration to determine a second similarity obtained by the next second iteration by selecting the updated target mask image as a target mask image and the second similarity as a first similarity for the next second iteration; and
obtaining the target subtracted image based on the updated target mask image obtained by the previous iteration and the live image if the second similarity obtained by the next second iteration is less than the first similarity for the next second iteration.

In an embodiment, a computer program product is provided which includes a computer program that, when executed by a processor, implements the following steps:
segmenting a target gradient image to obtain multiple image blocks, the target gradient image being a gradient image of a target image of an inspected object, the target image including any one of a mask image, a live image, or a subtracted image;
determining a number of control points to be selected for each image block based on a first preset number of control points and pixel values within each image block; and
identifying target control points in the target gradient image based on image block information of each image block, the image block information including the number of control points to be selected for the image block and a size of the image block.

In an embodiment, the processor when executing the computer program is also configured to perform the following steps:
selecting the image block that meets a preset condition as a first target image block;
performing a first iteration, which includes segmenting the first target image block to obtain multiple new image blocks for the current iteration and determining the number of control points to be selected for each new image block based on the number of control points for the first target image block and the pixel values within each new image block, and repeating the first iteration by selecting the new image block that meets the preset condition as a first target image block, until newly obtained image blocks no longer meet the preset condition; and
determining the target control points in each second target image block based on the pixel values within each second target image block. The second target image blocks include image blocks that are determined in each iteration but do not meet the preset condition.

In an embodiment, the processor when executing the computer program is also configured to perform the following steps:
determining whether each image block meets the preset condition based on the image block information of the image block; and
selecting the pixel with the maximum pixel value in each image block as the target control point if the image block does not meet the preset condition.

In an embodiment, the processor when executing the computer program is also configured to perform the following step:
determining, if the number of control points corresponding to an image block is greater than a second preset number of control points and the size of the image block is greater than a preset size, the image block to meet the preset condition and selecting the image block that meets the preset condition as the first target image block.

In an embodiment, the processor when executing the computer program is also configured to perform the following steps:
determining a weight of each image block in the target gradient image based on the pixel values within each image block; and
determining a number of control points to be selected for each image block based on the first preset number of control points and the weight of each image block.

In an embodiment, the processor when executing the computer program is also configured to perform the following steps:
determining a first similarity between the target mask image and the live image, the target mask image including the mask image, an image obtained by mapping the target control points in the live image to the mask image, or an image obtained by mapping the target control points in the subtracted image to the mask image, the target control points being identified using any method in the embodiments described above;
performing a second iteration, which includes identifying matching control points in the live image corresponding to the target control points in the target mask image, generating an updated target mask image for the current iteration based on control point pairs and the target mask image, and determining a second similarity between the updated target mask image and the live image for the current iteration, the control point pairs each including one target control point and one corresponding matching control point; and
determining a target subtracted image according to the first similarity and the second similarity, the target subtracted image being the image obtained by registering the live image and the target mask image.

In an embodiment, the processor when executing the computer program is also configured to perform the following steps:
if the second similarity is greater than or equal to the first similarity, performing a next second iteration to determine a second similarity obtained by the next second iteration by selecting the updated target mask image as a target mask image and the second similarity as a first similarity for the next second iteration; and
obtaining the target subtracted image based on the updated target mask image obtained by the previous iteration and the live image if the second similarity obtained by the next second iteration is less than the first similarity for the next second iteration.

The present disclosure also provides a non-transitory computer storage medium in which a computer program is stored. The computer program, when executed by a processor, causes the processor to perform a method for identifying control points according to any of the embodiments described above, and/or perform a method for image registration according to any of the embodiments described above.

It is to be noted that the user information (including, but not limited to, user device information, user personal information, etc.) and data (including, but not limited to, data used for analysis, data stored, data displayed, etc.) involved in the present disclosure are information and data authorized by the user or fully authorized by the parties.

Those of ordinary skill in the art can understand and implement the entire or partial processes described in the above embodiments by instructing relevant hardware through a computer program. The computer program can be stored in a non-transitory computer-readable storage medium. When executing the computer program, it may include the processes of the embodiments described above. In the various embodiments provided by this disclosure, any references to memory, databases, or other media can include at least one type of non-transitory and transitory memory. Non-transitory memory can include Read-Only Memory (ROM), magnetic tape, floppy disks, flash memory, optical memory, high-density embedded non-transitory memory, Resistive Random Access Memory (ReRAM), Magnetoresistive Random Access Memory (MRAM), Ferroelectric Random Access Memory (FRAM), Phase Change Memory (PCM), graphene memory, and so on. Transitory memory can include Random Access Memory (RAM) or external cache memory. As an illustration and not limitation, RAM can take various forms such as Static Random Access Memory (SRAM) or Dynamic Random Access Memory (DRAM). The databases involved in the various embodiments provided by this disclosure can include at least one type of relational database and non-relational database. Non-relational databases can include blockchain-based distributed databases, etc., not limited to this. The processors involved in the various embodiments provided by this disclosure can be general-purpose processors, central processors, graphics processors, digital signal processors, programmable logic devices, quantum computing-based data processing logic devices, etc., not limited to this.

The various technical features of the above embodiments can be combined arbitrarily, and in order to make the description concise, all possible combinations of the various technical features of the above embodiments have not been described; however, as long as there is no contradiction in the combinations of these technical features, all of them should be considered to be within the scope of the present specification.

The above-described embodiments express only several embodiments of the present disclosure, which are described in a more specific and detailed manner, but are not to be construed as a limitation of the scope of the patent of the present disclosure. It should be pointed out that, for a person of ordinary skill in the art, several deformations and improvements can be made without departing from the conception of the present disclosure, all of which fall within the scope of protection of the present disclosure. Therefore, the scope of protection of this disclosure shall be subject to the attached claims.

What is claimed is:

1. A method for identifying control points, comprising:
segmenting a target gradient image to obtain multiple image blocks, the target gradient image being a gradient image of a target image of an inspected object, the target image comprising any one of a mask image, a live image, or a subtracted image;
determining a number of control points to be selected for each image block based on a first preset number of control points and pixel values within each image block; and
identifying target control points in the target gradient image based on image block information of each image block, the image block information comprising the number of control points to be selected for the image block and a size of the image block.

2. The method of claim 1, wherein the identifying the target control points in the target gradient image based on image block information of each image block comprises:
selecting the image block that meets a preset condition as a first target image block;
performing a first iteration, which comprises segmenting the first target image block to obtain multiple new image blocks and determining a number of control points to be selected for each new image block based on the number of control points to be selected for the first target image block and pixel values within each new image block;
performing the first iteration by selecting the new image block that meets the preset condition as a first target image block;
repeating the first iteration until each newly obtained image block does not meet the preset condition, and selecting the image blocks that do not meet the preset condition in each first iteration as second target image blocks; and
identifying the target control points in each second target image block based on pixel values within the second target image block.

3. The method of claim 2, wherein the identifying the target control points in the target gradient image based on image block information of each image block comprises:
determining whether each image block meets the preset condition based on the image block information of each image block; and
selecting a pixel with the maximum pixel value in the image block as the target control point, if the image block does not meet the preset condition.

4. The method of claim 2, wherein the selecting the image block that meets the preset condition as the first target image block comprises:
determining that the image block meets the preset condition if the number of control points for the image block is larger than a second preset number of control points and the size of the image block is larger than a preset size; and
selecting the image block that meets the preset condition as the first target image block.

5. The method of claim 1, wherein the determining the number of control points to be selected for each image block based on the first preset number of control points and the pixel values within each image block comprises:
determining a weight of each image block in the target gradient image based on the pixel values within each image block; and
determining the number of control points to be selected for each image block based on the first preset number of control points and the weight of each image block.

6. The method of claim 1, wherein the determining the number of control points to be selected for each image block based on the first preset number of control points and the pixel values within each image block comprises:
determining the number of control points to be selected for each image block based on distribution of pixel values within each image block and the first preset number of control points.

7. A method for image registration, comprising:
identifying target control points in any one of a mask image, a live image, or a subtracted image, which comprises:
segmenting a target gradient image to obtain multiple image blocks, the target gradient image being a gradient image of a target image of an inspected object, the target image comprising any one of the mask image, the live image, or the subtracted image;
determining a number of control points to be selected for each image block based on a first preset number of control points and pixel values within each image block; and
identifying the target control points in the target gradient image based on image block information of each image block, the image block information comprising the number of control points to be selected for the image block and a size of the image block; and
obtaining a target subtracted image based on a target mask image and the live image, the target mask image comprising any one of the mask image with the target control points, an image obtained by mapping the target control points in the live image to the mask image, or an image obtained by mapping the target control points in the subtracted image to the mask image.

8. The method of claim 7, wherein the obtaining the target subtracted image based on the target mask image and the live image comprises:
determining a first similarity between the target mask image and the live image;
performing a second iteration, which comprises:
identifying matching control points in the live image corresponding to the target control points; and
generating an updated target mask image based on control point pairs and the target mask image, and determining a second similarity between the updated target mask image and the live image, the control point pairs being each composed of the target control point and the corresponding matching control point; and
obtaining the target subtracted image according to the first similarity and the second similarity.

9. The method of claim 8, wherein the obtaining the target subtracted image according to the first similarity and the second similarity comprises:
obtaining the target subtracted image by registering the live image and the updated target mask image if the second similarity is greater than or equal to the first similarity; or
obtaining the target subtracted image by registering the live image and the target mask image if the second similarity is less than the first similarity.

10. The method of claim 8, wherein the obtaining the target subtracted image according to the first similarity and the second similarity comprises:
if the second similarity is greater than or equal to the first similarity, performing a next second iteration to determine a second similarity obtained by the next second iteration by selecting the updated target mask image as a target mask image for the next second iteration and selecting the second similarity as a first similarity for the next second iteration; and
if the second similarity obtained by the next second iteration is less than the first similarity for the next second iteration, obtaining the target subtracted image based on the updated target mask image obtained by the previous second iteration and the live image.

11. The method of claim 8, further comprising selecting the matching control points in the live image as reference starting points for matching the target mask image and a next live image.

12. The method of claim 7, wherein the identifying the target control points in the target gradient image based on image block information of each image block comprises:
selecting the image block that meets a preset condition as a first target image block;
performing a first iteration, which comprises segmenting the first target image block to obtain multiple new image blocks and determining a number of control points to be selected in each new image block based on the number of control points to be selected for the first target image block and pixel values within each new image block;
performing the first iteration by selecting the new image block that meets the preset condition as a first target image block;
repeating the first iteration until each newly obtained image block does not meet the preset condition, and selecting the image blocks that do not meet the preset condition in each first iteration as second target image blocks; and
identifying the target control points in each second target image block based on pixel values within the second target image block.

13. The method of claim 12, wherein the identifying the target control points in the target gradient image based on image block information of each image block comprises:
determining whether each image block meets the preset condition based on the image block information of each image block; and
selecting a pixel with the maximum pixel value in the image block as the target control point, if the image block does not meet the preset condition.

14. The method of claim 12, wherein the selecting the image block that meets the preset condition as the first target image block comprises:
determining that the image block meets the preset condition if the number of control points for the image block is larger than a second preset number of control points and the size of the image block is larger than a preset size; and
selecting the image block that meets the preset condition as the first target image block.

15. The method of claim 7, wherein the determining the number of control points to be selected for each image block based on the first preset number of control points and the pixel values within each image block comprises:
determining a weight of each image block in the target gradient image based on the pixel values within each image block; and
determining the number of control points to be selected for each image block based on the first preset number of control points and the weight of each image block.

16. The method of claim 7, wherein the determining the number of control points to be selected for each image block based on the first preset number of control points and the pixel values within each image block comprises:
determining the number of control points to be selected for each image block based on distribution of pixel values within each image block and the first preset number of control points.

17. A computer device comprising a memory and a processor, the memory storing a computer program, wherein the processor, when executing the computer program, is configured to perform the method for identifying control points of claim 1.

18. A computer device comprising a memory and a processor, the memory storing a computer program, wherein the processor, when executing the computer program, is configured to perform the method for image registration of claim 7.

19. A non-transitory computer-readable medium having stored thereon a computer program, wherein the computer program, when executed by a processor, causes the processor to perform the method for identifying control points of claim 1.

20. A non-transitory computer-readable medium having stored thereon a computer program, wherein the computer program, when executed by a processor, causes the processor to perform the method for image registration of claim 7.
